(19) United States
(12) Patent Application Publication
(10) Pub. No.: US 2002/0196867 A1
(43) Pub. Date: Dec. 26, 2002

(54) Method for selectively demodulating data including power control bit in mobile station

(75) Inventor: Seong-II Yoon, Kyungki-Do (KR)

Correspondence Address: FLESHNER & KIM, LLP, P.O. Box 221200, Chantilly, VA, 20153-1200, US

(73) Assignee: LG Electronics Inc.

(21) Appl. No.: 10/175,921

(22) Filed: Jun. 21, 2002

(30) Foreign Application Priority Data
Jun. 25, 2001 (KR) 36351/2001

(51) Int. Cl. H04L 27/22; H04L 27/14; H04L 27/06

(52) U.S. Cl. 375/316

(57) ABSTRACT

A method for selectively modulating data in a mobile station, includes checking whether a power control bit is included in the received data, demodulating the received data including the power control bit, if the power control bit is included, and turning off the receiving power when demodulation is completed. The demodulating step includes demodulating an initially repeated data frame group at only one location in the data frame and demodulating data frame groups containing power control bits. The receiving power is then turned off without demodulating remaining groups in the data frame, which include groups which do not contain a power control bit.

### BACKGROUND OF THE INVENTION

1. Field of the Invention

The present invention relates to mobile communications, and more particularly to a method for selectively demodulating data received in a mobile communications system.

2. Background of the Related Art

Signals transmitted and received by terminals in a mobile communications system must have a maximized signal-to-noise radio (S/N) in order to realize efficient signal recovery, and this is especially true of Code Division Multiple Access (hereinafter, as CDMA systems). If, for example, the sending power of the terminal is low, service quality is lowered. If the sending power is high, service quality of the terminal is improved but other terminals using a same channel are affected and, accordingly, service quality of other subscribers is deteriorated.

The sending power of the respective terminals must therefore be controlled so that the powers of the respective terminals received in the base station are the same. This power may be used as a basis for defining a rate of signal- to -noise ratio sufficient to maintain a desired quality of communications for all users and it may also be used to maximize capacity.

Damage of the reverse channel cannot be predicted exactly based on a difference of the signals of the sending and receiving units, differences in fading characteristics caused since the frequency band is changed, and differences between the normal direction channel (in the direction from the base station to the mobile station) and reverse direction channel (in the direction from the mobile station to the base station). In order to correct such errors, the respective terminals adjust their output by a low-speed power control instruction transmitted from the base station over the normal direction channel.

The base station obtains the error correction information by observing the state of the reverse channel and instructs the terminal to raise or lower the output according to the result by comparing the information with the predetermined value. With such method, the base station adjusts the power of the reverse channels of all terminals and simultaneously achieves the desired level of service quality and a maximization of capacity.

The base station sets a reference value of Eb/No of a respective mobile station in the cell, and then compares the Eb/No value received from the mobile station with the reference value. The base station transmits a power increasing or decreasing instruction to the mobile station after comparing the reference value.

The power increasing or decreasing instruction is also called a power control sub-channel, and it is transmitted from the base station to the mobile station at a period of 1.25 msec (800 bps). The power control sub-channel includes a power control bit which is a control bit sent from the normal direction traffic channel to the mobile station at a period of 1.25 ms. The power control bit increases or decreases the sending power of the mobile station and varying amount of the average output for one power control bit is 1 dB.

After data scrambling, the power control sub-channel is included as a part of the traffic channel.

The power level of a mobile station can be changed sixteen times in a frame. Such a power control group is included in a traffic channel as a part, after data scrambling.

Information signals having different data rates have an identical data rate of 19.2 kbps after repeating a symbol. 384 symbols exist in a frame in unit of 20 msec. More specifically, there are 19.2 kbps*0.02 sec 384 symbols. Sixteen power control groups can be made by dividing the 384 symbols by 24 symbols. That is, the respective power control groups are transmitted in units of 1.25 msec and respectively include 24 symbols. Here, two symbols among the 24 symbols are selected and the two symbols are replaced by the power control bit.

FIG. 1 is a diagram showing a format of a general data frame including a power control bit. In this figure, the power control bit in the 8th power control group is replaced, and the position of the power control bits of the current control group is determined based on the last four symbols (20th to 23rd symbols) of the former control group. At this time, the 20th symbol is the least significant bit (hereinafter, as LSB) and the 23rd symbol is the most significant bit (hereinafter, as MSB). For instance, in case the former four symbols are (LSB)1101(MSB), this number is 11 when it is converted into a decimal number. Therefore, as shown in FIG. 1, the 11th and 12th symbols are replaced by the power control bit.

In operation, the base station transmits a power control group with the above composition to the mobile station through a code division multiple access (CDMA) traffic channel. The mobile station demodulates the received power control group in all received frames regardless of the current data rate. Each of the frames transmitted by the base station is formed by repeating the same data two times for the data rate of ½, four times for the data rate of ¼, and eight times for the data rate of ⅛. The mobile station then receives the frame composed of the repeated data and demodulates all of the power control group in the frame regardless of the data rate.

Because, the mobile station demodulates all the repeated data in a received data frame when, for example, the data rate is ½, ¼ or ⅛, the same modulating operations are repeatedly performed two, four, and eight times respectively. Therefore, the same amount of modulation is performed for low data rates as well as for high data rates and, accordingly, efficiency of the system of the mobile station is low and battery power is quickly consumed.

### SUMMARY OF THE INVENTION

An object of the present invention is to provide a method which demodulates data received by a terminal in a communication system more efficiently than conventional methods.

Another object of the present invention is to achieve the aforementioned object by demodulating only portions of a received data frame and not demodulating others.

Another object of the present invention is to use a data rate of a received data frame as a basis of determining which portions of the frame are to be demodulated and which portions are not to be demodulated.

Another object of the present invention is to provide a method for selectively demodulating data received in a communications system, by searching a data frame of received data to determine whether a portion of the data frame includes a power control bit, demodulating that portion, and not modulating the other portions of the data frame which do not include a power control bit.

To achieve these and other advantages and in accordance with the purpose of the present invention, as embodied and broadly described herein, there is provided a method for selectively searching and modulating data frame including the power control bit among the data received from the base station, in the mobile station, including the steps of checking whether a power control bit is included in the received data; demodulating the data including the power control bit, if the power control bit is included; and turning off the receiving power when demodulation is completed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a view showing a format of a general data frame which includes a power control bit;

FIG. 2 is a flowing chart illustrating a method for selectively demodulating a data frame including a power control bit in accordance with one embodiment of the present invention;

FIG. 3 is a view showing a format of the data frame of data rate of ½ having the power control bit in accordance with another embodiment of the present invention;

FIG. 4 is a view showing a format of the data frame of data rate of ¼ having the power control bit in accordance with another embodiment of the present invention; and

FIG. 5 is a view showing a format of the data frame of data rate of ⅛ having the power control bit in accordance with another embodiment of the present invention.

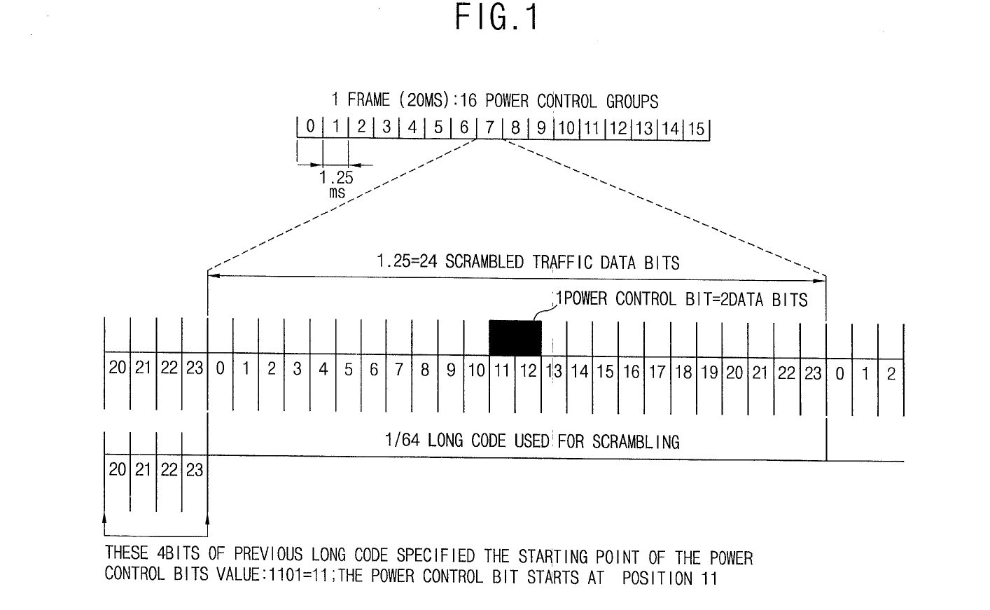

### DETAILED DESCRIPTION OF PREFERRED EMBODIMENTS

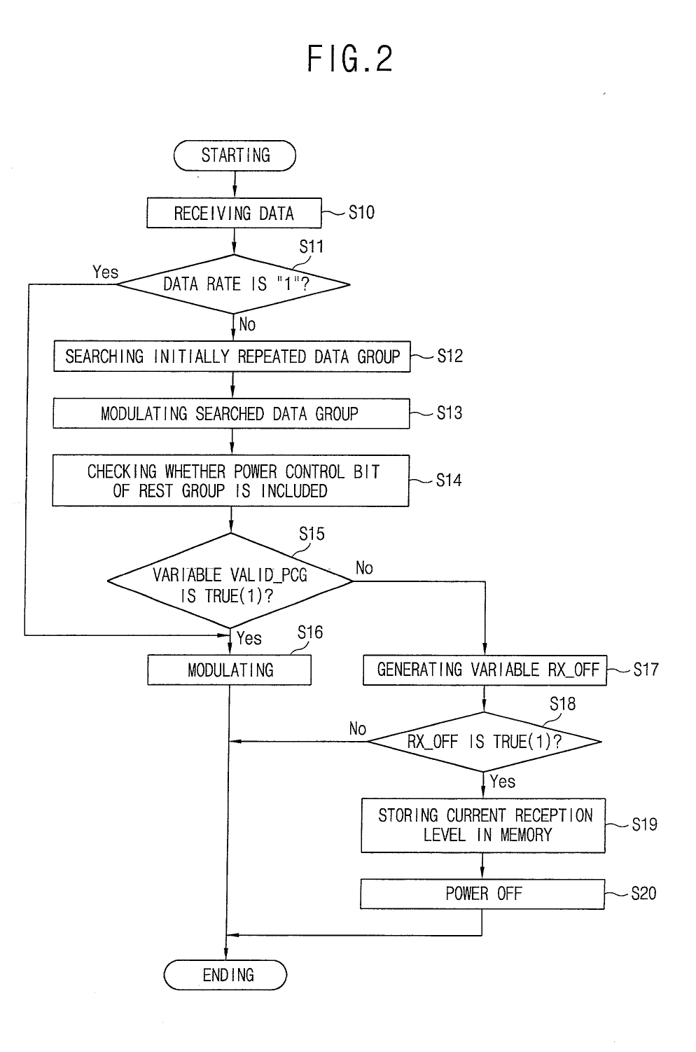

FIG. 2 is a flowing chart showing steps included in a method for selectively demodulating data in a mobile station of a communications system in accordance with one embodiment of the present invention. In an initial step, the mobile station receives data transmitted from the base station through the CDMA traffic channel and then checks whether a data rate of the received data is a predetermined value, for example, “1” (S10-S11).

If the data rate of the received data is “1”, the mobile station demodulates all of the groups of the received data frames same as conventionally (S16). However, if the data rate is not “1”, the mobile station calculates the repeated part from the receiving frame of 20 ms according to the data rate of the received data and searches the data frame group (S12).

In a next step, the mobile station demodulates the repeated data group which was first searched, and after demodulation, the mobile station checks whether the power control bit is included in the next data group by checking whether the variable valid_pcg is TRUE (1) (S14-S15). The variable valid_pcg is determined in the mobile station and indicates whether the power control bit received from the current base station is valid. If the variable valid_pcg is true (1), the mobile station demodulates the data frame including the power control bit since the data frame includes the power control bit (S16). However, if the variable valid_pcg is false (0), the mobile station does not demodulate the data frame since the power control bit is not included in the data frame and generates a variable RX_OFF to determine whether the receiving power of data frame which was not demodulated turn off(S17). The variable RX_OFF is a variable that can be set by the mobile station user and indicates whether the RX_POWER of a part which was not demodulated will be turned off. The receiving power off can be set arbitrarily by the mobile station user, that is, set by the user, by adding a receiving power on/off setting menu in the configuration menu of terminals. When the variable RX_OFF is generated, the mobile station determines whether the receiving power will be turned off by checking whether the generated variable RX_OFF is true (1) (S18). As the result of checking, when the variable RX_OFF is false (0), the mobile station does not perform demodulation. However, when the variable RX_OFF is true (1), it means that the receiving power of the data frame which was not demodulated is off. Therefore, the mobile station stores the current receiving level (received signal strength indication (RSSI)) in a memory (S19).

The current receiving level stored in the memory is used when the next receiving power is turned on. However, storage of the current receiving level can be selected by the user and the power can be turned off without storing the current receiving level. When the current receiving level is stored, the mobile station turns off the receiving power (S20).

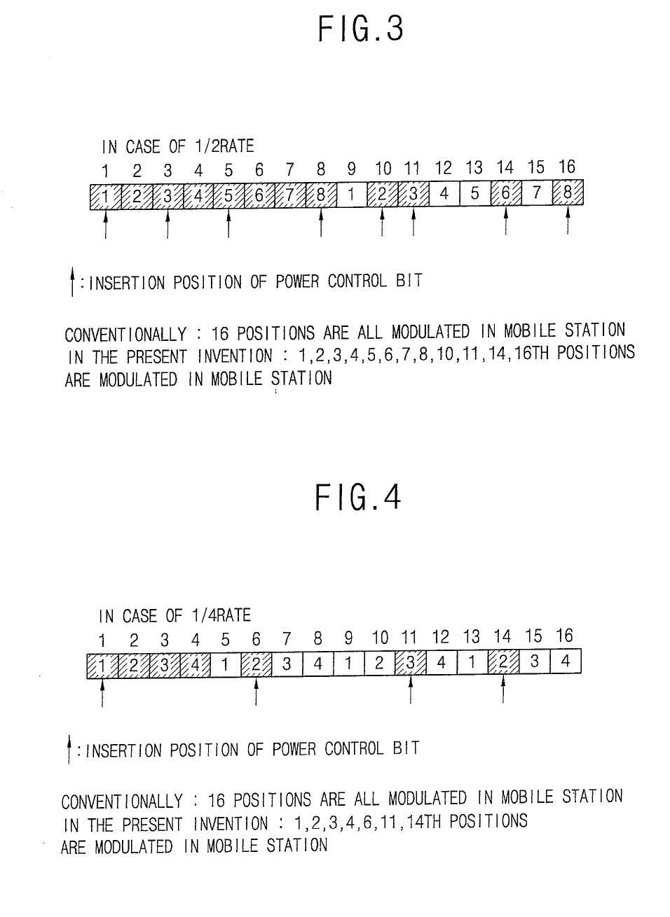

FIG. 3 shows one approach which may be taken by the present invention for demodulating repeated data and FIG. 3 is a view showing the format of the data frame having a data rate of ½.

Since the data frame has the data rate of ½, the same data is repeated two times in the CDMA traffic channels between the base station and mobile station, and the data frame is transmitted to the mobile station.

As shown in FIG. 3, the first to eighth groups of the data frame are demodulated, and the 10th, 11th, 14th and 16th groups of the ninth to sixteenth groups, including the power control bit, are demodulated. The demodulation process of the data frame having the data rate of ½ will now be described in detail with reference to FIG. 2 and 3.

Initially, the mobile station receives data from the base station (S10). The base station checks to determine whether the data rate of the received data is “1” (S11). If the data rate of the received data is not “1”, the mobile station checks that the data rate is ½ and searches for the initially repeated groups (S12). The mobile station demodulates the searched initially repeated groups(e.g., the first to eighth groups are demodulated) and then checks whether the rest of the data frame includes the power control bit (S13-S15).

The mobile station checks the variable valid_pcg in which the power control bit is stored, to determine whether the rest of the data frame includes the power control bit (15). If the variable valid_pcg is true (1), the mobile station searches the 10th, 11th, 14th and 16th data frames including the power control bit for the 9th to 16th groups and demodulates the 10th, 11th, 14th and 16th data frames including the power control bit (S16). The mobile station then generates a variable RX_OFF to determine whether the receiving power of the rest 9th, 12th, 13th and 15th data frames which were not demodulated, will be turned off (S17).

If it is supposed that the mobile station user sets power off arbitrarily, the mobile station checks whether the generated RX_OFF is true (1) and determines whether the receiving power will be turned off (S18). If the variable RX_OFF is true (1), the mobile station stores the current receiving level (RSSI) in the memory. It is supposed that storage of the current receiving level was set by the mobile station user. When the current receiving level is stored, the mobile station turns off the receiving power (S20).

FIG. 4 shows an embodiment where the demodulation process of the present invention is performed for a data frame having a data rate of ¼. Since the data frame has a data rate of ¼, the same data is repeated four times in the CDMA traffic channel between the base station and mobile station and the data frame is transmitted to the mobile station.

As shown in FIG. 4, the data of the 1st to 4th groups of the data frame having the data rate of ¼ are demodulated, and data from only the 6th, 11th and 14th groups are demodulated in the 5th to 16th groups. The demodulation process of the data frame having the data rate of ¼ will be described in detail with reference to FIGS. 2 and 4.

The mobile station receives the data from the base station (S10). The mobile station checks whether the data rate of the received data is “1” (S11). If the data rate of the received data is not “1”, the mobile station checks that the data rate is ¼ and searches the first group to be demodulated (S12). The mobile station demodulates the first group that was second, (e.g., the 1st to 4th groups) and checks whether the rest of the data frame includes the power control bit (S14-S15).

The mobile station checks the variable valid_pcg in which the power control bit is stored, to determine whether the rest of the data frame includes the power control bit. In this embodiment, the mobile station finds that the 6th, 11th and 14th groups include the power control bit as a result of the variable valid_pcg being true (1).

The mobile station demodulates the 6th, 11th and 14th data frames including the power control bit (S16). However, the mobile station generates a variable RX_OFF to determine whether the receiving power of the rest 5th, 7th, 8th, 9th, 10th, 12th, 13th, 15th and 16the data frames, which are not demodulated, will be turned off (S17). If it is supposed that the mobile station user set the receiving power off arbitrarily, the mobile station checks whether the generated variable RX_OFF is true (1) and determines whether the receiving power will be turned off (S18). If the variable RX_OFF is true (1), the mobile station stores the current receiving level (RSSI) in the memory (S19). It is supposed that storage of the current receiving level was set by the mobile station user. When the current receiving level is stored, the mobile station turns off the receiving power (S20).

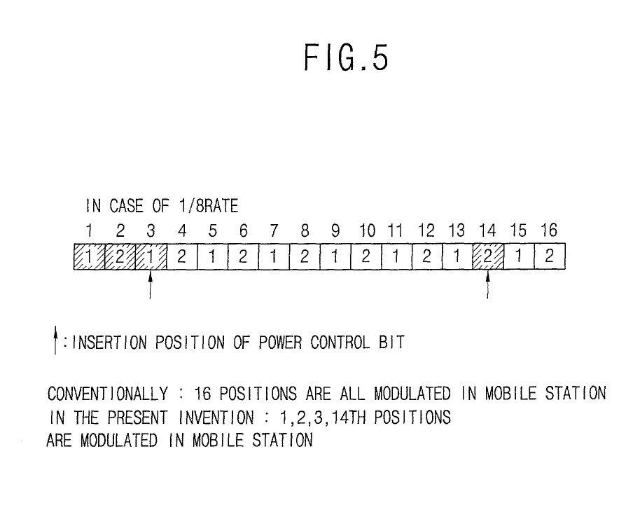

FIG. 5 shows an embodiment where the demodulation process of the present invention is performed for a data frame having a data rate of ⅛. Since the data frame has a data rate of ⅛, the same data is repeated eight times in the CDMA traffic channel between the base station and mobile station and the data frame is transmitted to the mobile station. As shown in FIG. 5, the first and second groups of the data frame are demodulated and only the 3rd and 14th groups including the power control bit are demodulated.

The demodulation process of the data frame having the data rate of ⅛ will now be described in detail with reference to FIGS. 2 and 5. In an initial step, the mobile station receives data from the base station (S10). The mobile station checks whether the data rate of the received data is “1” (S11). If the data rate of the received data is not “1”, the mobile station determines whether the data rate is ⅛ and searches a first group, or set of groups, to be demodulated (S12). In this embodiment, the mobile station demodulates the first searched group in the data frame, (e.g., the 1st and 2nd groups), and then checks whether the rest of the data frame includes the power control bit (S14-S15).

The mobile station checks the variable valid_pcg in which the power control bit is stored, to determine whether the rest of the groups in the data frame includes the power control bit. As the result of checking, the mobile station finds that the 3rd and 14th groups in the data frame includes the power control bit as a result of the variable valid_pcg being true (1).

The mobile station demodulates the 3rd and 14th groups of the data frame which include the power control bit (S16). However, the mobile station generates a variable RX_OFF to determine whether the receiving power of the rest 4th to 13th and 15th to 16th groups, which are not demodulated, will be turned off (S17). If it is supposed that the mobile station user sets the receiving power off arbitrarily, the mobile station checks whether the generated variable RX_OFF is true (1) and determines whether the receiving power will be turned off (S18). If the variable RX_OFF is true (1), the mobile station stores the current receiving level (RSSI) in the memory (S19). It is also supposed that storage of the current receiving level was set by the mobile station user. When the current receiving level is stored, the mobile station turns off the receiving power (S20). Thus, with the power control method of the present invention, one or more portions (or groups) of a data frame are demodulated if it contains a power control bit, and this demodulation is performed based on a data rate of the data frame. Portions (groups) of the data frame which does not include a power control bit, is not demodulated or the receiving power is turned off, thereby increasing the efficiency of operation of the mobile station.

Also, the power control method of the present invention may advantageously increase the life of the mobile terminal battery and reduce consumption of the power.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims. For example, while the illustrative embodiments discussed herein demodulate sets of groups in a received data frame which are 2, 4, and 8 groups in size, the invention contemplates searching and demodulating sets of groups of other sizes including sets, which include only one group to sets of groups greater than 8 groups.

What is claimed is:

1. A method for selectively demodulating data in a mobile station, comprising:
checking whether a power control bit is included in received data;
demodulating the received data if the power control bit is included; and
turning off receiving power of the mobile station.

2. The method of claim 1, wherein the mobile station demodulates all groups in a data frame included in the received data if a data rate of the received data is a predetermined rate.

3. The method of claim 1, wherein checking the step includes:
searching a data frame in the received data to locate a first set of groups which repeat in the data frame;
demodulating the first set of groups in the data frame; and
checking whether at least another group in the data frame includes the power control bit when demodulation of the first set of groups is completed.

4. The method of claim 1, wherein the checking step includes:
checking whether a variable valid_pcg in which the power control bit is stored is true.

5. The method of claim 4, wherein the checking step further includes:
determining that the data frame includes the power control bit, if the variable valid_pcg is TRUE(1).

6. The method of claim 1, further comprising:
searching a data frame in the received data to locate a set of groups in the data frame which repeat, said searching step including calculating a length of the repeated set of groups in the data frame based on a data rate of the received data.

7. The method of claim 1, further comprising:
performing no demodulation if no power control bit is included in the data frame.

8. The method of claim 1, wherein the turning off step includes:
generating a variable RX_OFF;
checking whether the variable RX_OFF is true;
storing a current receiving level (received signal strength indication) in a memory, if the variable RX_OFF is true; and
turning off receiving power when storage is completed.

9. The method of claim 8, wherein the mobile station does not perform demodulation if the variable RX_OFF is false.

10. The method of claim 8, wherein the step of turning off the receiving power can be set by the mobile station user arbitrarily.

11. The method of claim 8, wherein the step of storing the current receiving level is set by the mobile station user arbitrarily.

12. The method of claim 8, wherein the current receiving level is used for a next receiving power when power of the mobile station is turned back on.

13. A method for selectively demodulating data in a mobile station, comprising:
checking whether a data rate of data received from a base station corresponds to a predetermined value;
if the data rate does correspond to the predetermined value, then
(a) searching a data frame in the received data to locate a first set of groups which repeats in the data frame;
(b) demodulating the first set of groups in the data frame;
(c) checking whether a power control bit is included in at least one other group in the data frame when demodulation is completed;
(d) demodulating said at least one other graph in the data frame which includes the power control bit, if the power control bit is included; and not demodulating
(e) turning off receiving power of the mobile station when demodulation is completed.

14. The method of claim 13, further comprising:
demodulating all groups in the data frame, if the data rate of the receive data is said predetermined value.

15. The method of claim 13, wherein the checking step includes:
determining whether a variable valid_pcg is true.

16. The method of claim 13, further comprising:
concluding that a power control bit is included in the second set of groups in the data frame if the variable valid_pcg is true.

17. The method of claim 13, wherein the searching step includes:
calculating a length of the repeated first set of groups in the data frame based on the data rate of the received data.

18. The method of claim 13, wherein the turning off step includes:
generating a variable RX_OFF;
checking whether the variable RX_OFF is true;
storing a current receiving level in a memory, if the variable RX_OFF is true; and
turning off the receiving power when the storing step is completed.

19. The method of claim 18, wherein demodulation is not performed if the variable RX_OFF is false.

20. The method of claim 18, wherein the step of turning off the receiving power is adjusted by a mobile station user arbitrarily.

21. The method of claim 18, wherein storage of the current receiving level is adjusted by a mobile station user arbitrarily.

22. The method of claim 21, further comprising:
storing the current receiving level in a memory, and setting a next receiving power of the mobile station based on the current receiving level when power of the mobile station is turned on.

23. The method of claim 3, further comprising:
demodulating said another group which includes the power control bit and not demodulating at least one other group which does not include the power control bit.

24. A method for selectively demodulating data in a communications system, comprising:
receiving a data frame having a plurality of groups; and
demodulating only a portion of the groups in the data frame, said demodulating step being performed based on a data rate of the data frame.

25. The method of claim 24, wherein if the data rate of the data frame does not equal a predetermined value, then:
searching the data frame to locate a set of groups which repeat in the data frame; and
demodulating the set of groups at only one location in the data frame.

26. The method of claim 25, wherein if the data rate of the data frame does not equal a predetermined value, then:
determining whether remaining ones of said groups in the data frame include a power control bit; and
demodulating the remaining ones of said groups which include a power control bit and not demodulating other remaining groups which do not include a power control bit.

27. A method for selectively demodulating data in a communications system, comprising:
receiving a data frame having a plurality of groups; and
demodulating a first portion of the groups in the data frame which include a power control bit and not demodulating a second portion of the groups in the data frame which do not include a power control bit.

28. The method of claim 27, further comprising:
determining whether the data frame includes a repeating set of groups;
demodulating the repeating set of groups at only one location in the data frame; and
demodulating remaining ones of said groups which include a power control bit.

29. The method of claim 28, wherein said determining step is performed based on a data rate of the data frame.

30. A signal-receiving system, comprising:
a receiver which receives a data frame having a plurality of groups; and
a demodulator which demodulates only a portion of the groups in the data frame based on a data rate of the data frame.

31. The system of claim 30, further comprising:
a processor which determines a data rate of the data frame;
a comparing unit which determines whether the data rate equals a predetermined rate,
wherein if the data rate of the data frame does not equal a predetermined value, the processor searches the data frame to locate a set of groups which repeat in the data frame and the demodulator demodulates the set of groups at only one location in the data frame.

32. The system of claim 31, wherein if the data rate of the data frame does not equal a predetermined value, then:
the processor determines whether remaining ones of said groups in the data frame include a power control bit; and
the demodulator demodulates the remaining ones of said groups which include a power control bit and does not demodulate other remaining groups which do not include a power control bit.

33. A signal-receiving system, comprising:
a receiver which receives a data frame having a plurality of groups; and
a demodulator which demodulates a first portion of the groups in the data frame which include a power control bit and which does not demodulate a second portion of the groups in the data frame which do not include a power control bit.

34. The system of claim 33, further comprising:
a processor which determines whether the data frame includes a repeating pattern of groups, wherein the demodulator demodulates said repeating pattern of groups at only one location in the data frame and demodulates only remaining ones of said groups which include a power control bit.

35. The system of claim 34, wherein the processor determines, whether the data frame has a repeating pattern of groups based on a data rate of the data frame.
